(19) United States
(12) Patent Application Publication
(10) Pub. No.: US 2024/0296842 A1
(43) Pub. Date: Sep. 5, 2024

(54) CONVERSATION DEVICE, CONVERSATION CONTROL METHOD, AND CONVERSATION PROGRAM

(71) Applicant: NIPPON TELEGRAPH AND TELEPHONE CORPORATION, Tokyo (JP)

(72) Inventors: Ko MITSUDA, Musashino-shi, Tokyo (JP); Ryuichiro HIGASHINAKA, Musashino-shi, Tokyo (JP); Tetsuya KINEBUCHI, Musashino-shi, Tokyo (JP)

(73) Assignee: NIPPON TELEGRAPH AND TELEPHONE CORPORATION, Tokyo (JP)

(21) Appl. No.: 18/573,449

(22) PCT Filed: Jun. 30, 2021
(86) PCT No.: PCT/JP2021/024875

§ 371 Date: Dec. 22, 2023

(51) Int. Cl. G10L 15/22; G10L 15/06; G10L 15/26

(52) U.S. Cl. CPC G10L 15/22; G10L 15/063; G10L 15/26; G10L 2015/0638

(57) ABSTRACT

An utterance information acquisition unit acquires utterance information of a collaborator who performs collaborative work for achieving a task through a dialogue. A dialogue control unit acquires information regarding the process of achieving the task by a plurality of workers performing the collaborative work through a dialogue and generates a system utterance by using an estimation model on the basis of the utterance information acquired by the utterance information acquisition unit, the information regarding the process, and main result information indicating an intermediate result of the collaborative work by the own device. An output unit outputs the system utterance generated by the dialogue control unit to the collaborator.

### TECHNICAL FIELD

The present invention relates to a dialogue device, a dialogue control method, and a dialogue program.

### BACKGROUND ART

In a dialogue system, a human has a dialogue with a computer to collect various kinds of information and satisfy demands. There is also a dialogue system that not only achieves a predetermined task but also has daily conversation. By such the dialogue system that has daily conversation, the human ensures his/her mental stability, satisfies the desire for recognition, and builds a relationship of trust. As described above, there are various types of dialogue systems.

A current chat-oriented dialogue system is mainly a one-question/one-answer system that does not have information regarding a state established by dialogues so far and selects and generates a system utterance on the basis of information regarding a previous user utterance. The one-question/one-answer chat-oriented dialogue system cannot have a more complicated dialogue than one question and one answer and thus has a problem that the degree of satisfaction of a user is low in a case of a chat that requires a complicated conversation. As means for solving the above problem, there is a method of causing a system to have information called a common base. The common base is information in a dialogue, such as knowledge and belief shared among participants of the dialogue, and is also called mutual belief.

The common base is one of important concepts in modeling a dialogue, but, at the present time, there are few studies that analyze the process of establishing the common base. For example, as an attempt to model establishment of the common base, there is a study that collects and analyzes speech dialogues of two workers achieving a task.

### CITATION LIST

### Non Patent Literature

Non Patent Literature 1: Takuma Udagawa and Akiko Aizawa, A natural language corpus of common grounding under continuous and partially-observable context, In Proc. AAAI, pp. 7120-7127, 2019.

### SUMMARY OF INVENTION

### Technical Problem

In the study using the conventional common base, a result of a task performed by workers is regarded as the common base, and a relationship between a dialogue and the common base is analyzed. However, the process of achieving the task is not quantitatively recorded. Therefore, it is difficult to grasp how the common base has been established through the dialogue, and thus it is difficult to establish a dialogue system based on the common base.

The present invention has been made in view of the above circumstances, and an object thereof is to achieve an advanced conversation with a user.

### Solution to Problem

In order to solve the above problem and achieve the object, an utterance information acquisition unit acquires utterance information of a collaborator who performs collaborative work for achieving a task through a dialogue. A dialogue control unit acquires information regarding the process of achieving the task by a plurality of workers performing the collaborative work through the dialogue and generates a system utterance by using an estimation model on the basis of the utterance information acquired by the utterance information acquisition unit, the information regarding the process, and main result information indicating an intermediate result of the collaborative work by the own device. An output unit outputs the system utterance generated by the dialogue control unit to the collaborator.

### Advantageous Effects of Invention

The present invention can achieve an advanced conversation with a user.

### BRIEF DESCRIPTION OF DRAWINGS

FIG. 1 is a block diagram of a dialogue device according to an embodiment.

FIG. 2 illustrates an example of a dialogue registered in a collaborative corpus.

FIG. 3 illustrates a work example of collaborative figure layout work.

FIG. 4 illustrates an output example of an utterance information acquisition unit.

FIG. 5 is a block diagram regarding a learning function of a dialogue control unit using a collaborative corpus.

FIG. 6 is a flowchart of learning processing of an estimation model by a dialogue device according to an embodiment.

FIG. 7 is a flowchart of dialogue control processing by a dialogue device according to an embodiment.

FIG. 8 illustrates an example of a computer that executes a dialogue program for dialogue control processing.

### DESCRIPTION OF EMBODIMENTS

Hereinafter, an embodiment of a dialogue device, a dialogue control method, and a dialogue program disclosed in the present application will be described in detail with reference to the drawings. The dialogue device, the dialogue control method, and the dialogue program disclosed in the present application is not limited by the following embodiment.

### EMBODIMENT

### [Device Configuration]

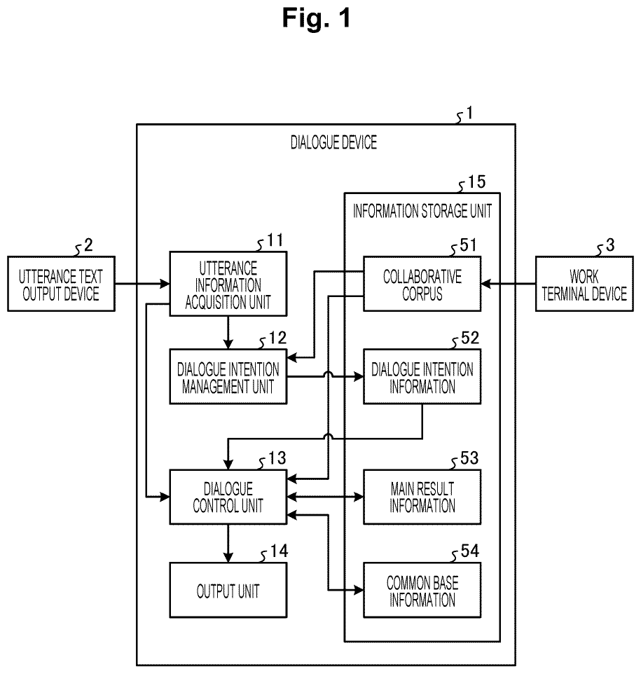

FIG. 1 is a block diagram of a dialogue device according to an embodiment. As illustrated in FIG. 1, a dialogue device 1 includes an utterance information acquisition unit 11, a dialogue intention management unit 12, a dialogue control unit 13, an output unit 14, and an information storage unit 15. The dialogue device 1 collaboratively performs independent work through a dialogue with a user who is a collaborator and solves a given task. The work that the dialogue device 1 collaboratively performs with the user through a dialogue will be referred to as collaborative work. The dialogue device 1 is connected to an utterance text output device 2 and a work terminal device 3.

The utterance text output device 2 is, for example, a device that recognizes a speech utterance input to a microphone, converts the speech utterance into a text, and outputs the text to the dialogue device 1. The utterance text output device 2 may output text information of an utterance input by the user operating an input device such as a keyboard.

The work terminal device 3 is a terminal used by a plurality of other workers when the plurality of other workers collaboratively performs the collaborative work performed by the dialogue device 1 with the user. The work terminal device 3 outputs, to the dialogue device 1, information regarding a dialogue exchanged when the plurality of other workers performs the collaborative work and information regarding the process of the work.

The information storage unit 15 is a storage device that stores various kinds of information used for a dialogue, such as a hard disk. The information storage unit 15 holds a collaborative corpus 51, dialogue intention information 52, main result information 53, and common base information 54.

The collaborative corpus 51 is information in which sentences representing a dialogue of each worker when a plurality of workers independently solves a task through a dialogue and the process of work are collected. That is, the collaborative corpus is information regarding the process of achieving a task by a plurality of workers performing collaborative work through a dialogue. In the collaborative corpus 51, the process of the work is associated not only with the sentences representing the dialogue but also with a specific sentence. That is, the collaborative corpus 51 indicates what kind of work has been performed when a specific dialogue has been performed. For example, in a case where the work is moving a figure on the xy coordinate plane, the information indicating what kind of work has been performed is represented as which figure has been moved to which position in the xy coordinates.

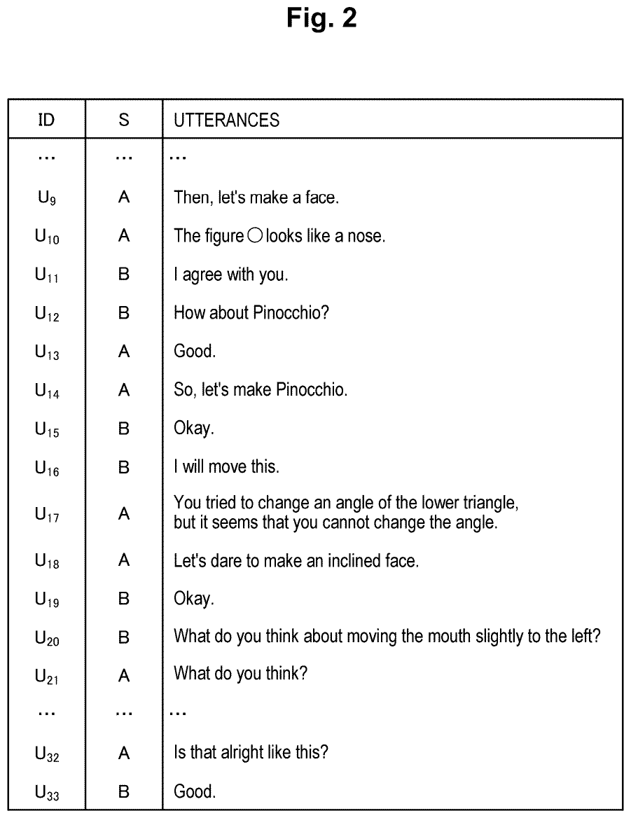

The collaborative corpus 51 acquires and stores the information regarding the dialogue exchanged when the plurality of other workers performs the collaborative work and the information regarding the process of the work transmitted from the work terminal device 3. FIG. 2 illustrates an example of a dialogue registered in the collaborative corpus. In the present embodiment, the collaborative corpus 51 obtained in a case where two workers perform collaborative work will be described as an example. An “ID” represents an identification number of each utterance. The symbol “S” represents the worker. The utterance is information indicating the content of the utterance made by the worker.

Specifically, FIG. 2 illustrates a dialogue collected in a case where workers A and B perform collaborative figure layout work. The collaborative figure layout work is a task in which two workers independently lay out figures while having a dialogue with each other. Although not illustrated in FIG. 2, in the collaborative corpus 51, the process of the work is associated with some of the sentences in FIG. 2 as described above.

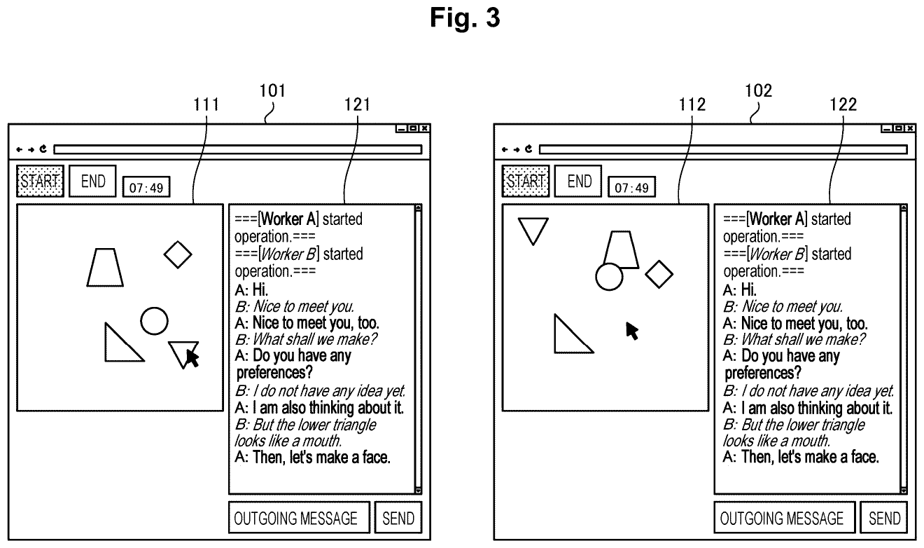

FIG. 3 illustrates a work example of the collaborative figure layout work. A screen 101 in FIG. 3 is a work screen of the worker A. A screen 102 is a work screen of the worker B. The screens 101 and 102 are displayed on the work terminal device 3 operated by the worker A and the work terminal device 3 operated by the worker B, respectively. The worker A does not check the screen 102, and conversely, the worker B does not check the screen 101. The workers A and B collaboratively perform work of completing their own pictures while mutually imagining a working state of the other party on the basis of a dialogue.

Figure layout screens 111 and 112 are work spaces for laying out figures. Chat screens 121 and 122 are spaces for displaying an utterance of each worker as a text. Buttons for starting and ending the work are placed in an upper part of the screen, and a remaining time of the work set to be, for example, a maximum of 10 minutes is displayed. Because a set of the same figures is given in a random layout, the workers A and B discuss how to lay out the figures by using the chat screens 121 and 122 and determine a common layout. In the figure layout screens 111 and 121, the figures cannot be rotated, scaled, or deleted, but can be planarly moved by using a mouse. The work terminal device 3 records start and end times of drag and drop of the figures and respective coordinates thereof as an operation log. The work terminal device 3 stores the operation log in the collaborative corpus 51 as the information regarding the process of the work.

For example, the worker A changes a layout position of each figure on the figure layout screen 111 on the basis of the dialogue with the worker B displayed on the chat screen 121 and determines a layout of the figures based on his/her own image. The worker B changes the layout position of each figure on the figure layout screen 112 and determines a layout of the figures on the basis of his/her own image. Because the workers A and B determine the layout of the figures according to their respective images, there is a low possibility that the workers make the same picture, but there is a high possibility that the pictures in which the figures are laid out are partially match. At this time, by recording the figure layout during the work and regarding a part of the figure layout as the common base, the common base can be quantitatively recorded.

In the present embodiment, the following two types of figures are prepared as figures to be laid out: a simple figure that is the simplest figure; and a figure of a building for which prior knowledge regarding figures is considered to be usable. The simple figure and the figure of the building each include ten types of figures. The number of figures of each type is five or seven including some same figures, and the figures are initially laid out with random sizes and positions.

For example, in a case where the collaborative figure layout work is performed as illustrated in FIG. 2, the workers A and B agree on a final layout image until U15. Then, the workers A and B lay out the figures while discussing the layout with each other after U16. Among the utterances, there is an utterance related to establishment of the common base, such as an utterance for checking a mutual layout as in U21. Therefore, the dialogue device 1 learns a method of generating an utterance and estimating a main work result and a work result of the collaborator by using the collaborative corpus 51, thereby establishing a system capable of achieving a collaborative figure layout task with the user who is the collaborator through a dialogue.

Description will be continued by referring back to FIG. 1. The dialogue intention information 52 is source information for determining how to perform a dialogue and is information set according to a purpose of the dialog. In the dialogue intention information 52, an initial value is registered in advance by the user. In the present embodiment, the dialogue intention information 52 is managed as a list of natural sentences.

For example, in a case of the collaborative figure layout work, the dialogue intention information 52 includes a sentence “The own picture and the other party's picture are aligned through a dialogue.” as an initial value on the basis of a condition of the task. Further, intentions such as “to make a beautiful layout” and “to make a Pinocchio's face” are added and updated through the dialogue as the dialogue intention information 52 by the dialogue intention management unit 12 described later.

The main result information 53 is information regarding a result of work mainly performed by the dialogue device 1. The main result information 53 is information indicating an intermediate result of the collaborative work by the own device. For example, in a case of the collaborative figure layout work, the main result information 53 is a picture which is created by the dialogue device 1 and in which the figures are laid out. The main result information 53 reflects the content of the latest dialogue and can be regarded as a result of understanding by the dialogue device 1. That is, the main result information 53 is an estimation result by the dialogue control unit 13. For example, in a case of the collaborative figure layout work, the main result information 53 holds types of figures and coordinates thereof as a text or numerical values.

The common base information 54 is information indicating a part common to a work result of the other party in the dialogue and the main result information 53 that is a work result of the dialogue device 1. For example, a picture created by the other party in the dialogue and the picture created by the dialogue device 1 in the collaborative figure layout work can be regarded as work results that reflect how the other party and the dialogue device each understand the content of the dialogue. Therefore, when a scale for quantitatively measuring the common base is introduced as the common base information 54, it is possible to mechanically handle information regarding how much the common base has been established, for example, which figure can be regarded as the common base in a case of the collaborative figure layout work. In the present embodiment, a distance of a difference between vectors defined between two arbitrary figures is used as the scale for quantitatively measuring the common base.

In the present embodiment, a difference between a vector v_{A, ij} defined between figures i and j in the figure layout of the worker A and a vector v_{B, ij} similarly defined by the worker B is used as a scale of whether or not each figure is grounded. Then, the sum of the distances between the figures is used as a scale of how much the common base has been established as the entire picture. As a value of the scale of how much the common base has been established as the entire picture is lower, the common base is more established.

For example, it is possible to determine how much the common base with the other party of the work has been established on the basis of the common base information 54. Therefore, in a case where the common base information 54 exceeds a certain value, it is possible to, for example, perform control to end the dialogue. Further, when the common base information 54 is presented to the other party of the collaborative work, it is possible to share understanding of approximately what percentage of the work matches.

The utterance information acquisition unit 11 receives a user utterance represented by a text from the utterance text output device 2. That is, the utterance information acquisition unit 11 acquires utterance information of the collaborator who performs collaborative work for achieving a task through a dialogue. Next, the utterance information acquisition unit 11 performs language analysis on the received user utterance. Thereafter, the utterance information acquisition unit 11 outputs the analysis result to the dialogue intention management unit 12 and the dialogue control unit 13.

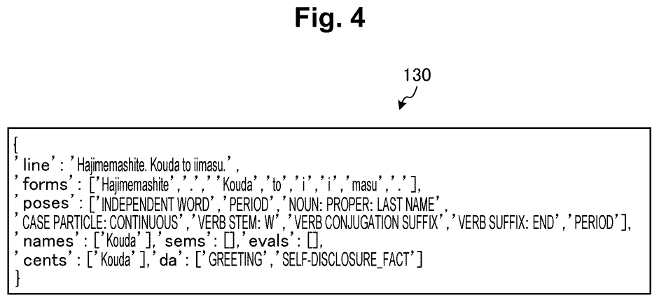

For example, the utterance information acquisition unit 11 performs morphological analysis, focal word extraction for extracting a keyword representing a topic, proper noun extraction, evaluation expression extraction, modality extraction for extracting, for example, whether or not there is a negative expression, and dialogue act estimation. FIG. 4 illustrates an output example of the utterance information acquisition unit. In an output example 130, the term “line” represents an input sentence. The terms “forms” and “poses” represent results of the morphological analysis by the utterance information acquisition unit 11. The term “names” represents a result of the proper noun extraction by the utterance information acquisition unit 11. The term “sems” represents a result of the modality extraction by the utterance information acquisition unit 11. The term “evals” represents a result of the evaluation expression extraction by the utterance information acquisition unit 11. The term “cents” represents a result of the focal word extraction by the utterance information acquisition unit 11. The term “da” represents an estimation result of the dialogue act estimation by the utterance information acquisition unit 11.

The dialogue intention management unit 12 refers to, for example, a dialogue text of the collaborative corpus 51 to specify an utterance regarding “suggestion” in a dialogue act as a possibility for extracting a dialog intention. Here, the dialogue act is obtained as, for example, information estimated by using an estimator based on a system disclosed in “Toyomi Meguro, Ryoichiro Higashinaka, Kohji Dohsaka, and Yasuhiro Minami, Creating a Dialogue Control Module for Listening Agents Based on the Analysis of Listening-oriented Dialogue, Transactions of Information Processing Society of Japan, Vol. 53, No. 12, pp. 2787-2801”. Then, the dialogue intention management unit 12 extracts, as a possibility, an utterance whose matching degree of a character string with an utterance of the user is equal to or greater than a threshold by using the Levenshtein distance or the like from specified utterances. The threshold of the matching degree can be set to 0.8 in a case where, for example, the Levelshtein distance is used. Then, the dialogue intention management unit 12 updates the dialogue intention information 52 by adding the extracted word or sentence to the dialogue intention information 52.

In this manner, the dialogue intention management unit 12 specifies the dialog intention of the dialogue with the user who is the collaborator on the basis of the utterance information acquired by the utterance information acquisition unit 11 and the information regarding the process of achieving a task by a plurality of workers performing collaborative work through a dialog.

### (Learning Processing of Estimation Model)

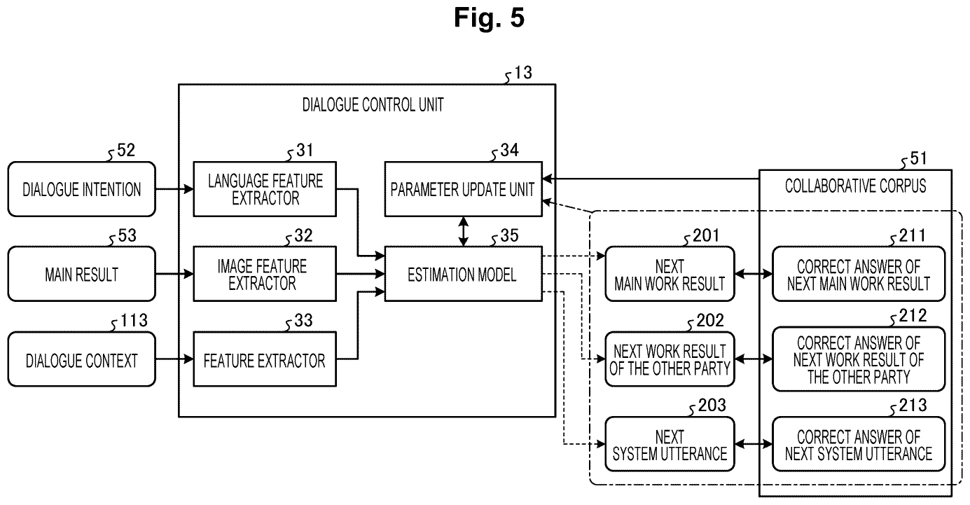

The dialogue control unit 13 learns an estimation model to be used for estimation on the basis of the collaborative corpus 51. FIG. 5 is a block diagram regarding a learning function of the dialogue control unit using the collaborative corpus. In the present embodiment, the dialogue control unit 13 performs learning by using multi-task learning that simultaneously performs learning on a plurality of different outputs in parallel.

As illustrated in FIG. 5, the dialogue control unit 13 includes a language feature extractor 31, an image feature extractor 32, a feature extractor 33, a parameter update unit 34, and an estimation model 35. The dialogue control unit 13 receives input of the dialogue intention information 52, information regarding a main work result, and information regarding a dialogue context. Here, the dialogue control unit 13 extracts the information regarding the main work result and the information regarding the dialogue context from the collaborative corpus 51 and uses the above information as inputs.

For example, in a case of the collaborative corpus 51 in which two workers perform collaborative work, the dialogue control unit 13 selects one of the workers. Then, the dialogue control unit 13 selects a sentence of an utterance of the selected worker at a specific dialogue stage from a dialogue text. Then, the dialogue control unit 13 acquires a previous utterance of the other party with respect to the selected sentence as the dialogue context. Further, the dialogue control unit 13 acquires, as the main work result, a work result of the selected worker finally associated with the selected sentence or a sentence therebefore.

The language feature extractor 31 converts the input dialogue intention information 52 into a vector representation and converts the vector representation into a format processable by the estimation model 35. The language feature extractor 31 can be implemented by, for example, converting a sentence into a vector by using Bidirectional Encoder Representations from Transformers (BERT).

The image feature extractor 32 converts the input main result information 53 into a vector representation and converts the vector representation into a format processable by the estimation model 35. The image feature extractor 32 can be implemented by, for example, converting an image into a vector by using ResNet.

The feature extractor 33 converts the input dialogue context into a vector representation and converts the vector representation into a format processable by the estimation model 35. Here, the feature extractor 33 and the estimation model 35 can be collectively learned as a single deep learning model.

The estimation model 35 can be implemented by using a deep learning framework such as PyTorch Lightning as the multi-task learning. The estimation model 35 preferably prepares output layers according to a plurality of pieces of information to be output. For example, in the present embodiment, three of a next main work result, a next work result of the other party, and a next system utterance are prepared as the output layers of the estimation model 35.

The parameter update unit 34 acquires an estimation result that is an output of each output layer of the estimation model 35 from the estimation model 35. Further, the parameter update unit 34 analyzes the collaborative corpus 51 to acquire a correct answer label corresponding to the estimation result. Specifically, the parameter update unit 34 acquires the correct answer label of the next system utterance from sentences of the dialogue included in the collaborative corpus 51. The parameter update unit 34 also acquires correct answer labels of the next main work result and the next work result of the other party by using the process of the work associated with the sentences included in the collaborative corpus 51. Then, the parameter update unit 34 calculates errors between the estimation results output from the estimation model 35 and the correct answer labels.

For example, the parameter update unit 34 acquires a next main work result 201, a next work result 202 of the other party, and a next system utterance 203 in FIG. 5 as the estimation results output from the estimation model 35. Next, the parameter update unit 34 analyzes the collaborative corpus 51 and acquires a correct answer 211 of the next main work result, a correct answer 212 of the next work result of the other party, and a correct answer 213 of the next system utterance as the correct answer labels of the respective estimation results. Then, the parameter update unit 34 calculates an error between the next main work result 201 and the correct answer 211 of the next main work result, an error between the next work result 202 of the other party and the correct answer 212 of the next work result of the other party, and an error between the next system utterance 203 and the correct answer 213 of the next system utterance.

Next, the parameter update unit 34 adjusts and updates parameters so as to minimize the respective errors. Thereafter, the parameter update unit 34 feeds back information regarding the updated parameters to the estimation model 35.

The dialogue control unit 13 repeatedly updates the parameters of the estimation model 35 until a predetermined learning end condition is satisfied. The learning end condition may be, for example, a case where the number of updates exceeds a predetermined number of times or a case where the error reaches a predetermined error threshold. By performing such the multi-task learning, the dialogue control unit 13 can perform learning such that an appropriate value is output in all the output layers of the estimation model 35. In this manner, the dialogue control unit 13 updates the estimation model 35 on the basis of the information regarding the process of achieving a task by a plurality of workers performing collaborative work through a dialogue and the main result information 53.

### (Estimation Processing)

The dialogue control unit 13 updates the main result information 53, estimates a work result of the other party, and generates a system utterance on the basis of an input user utterance. Specifically, the dialogue control unit 13 receives input of text information of the user utterance from the utterance text output device 2. Further, the dialogue control unit 13 acquires the dialogue intention information 52 from the information storage unit 15. The dialogue control unit 13 further acquires the main result information 53 from the information storage unit 15.

Then, the dialogue control unit 13 estimates a next main work result, estimates a next work result of the other party, and estimates a system utterance that is a next utterance from the own device by using the held learned estimation model on the basis of the acquired user utterance, the dialogue intention information 52, and the main result information 53.

Then, the dialogue control unit 13 stores the estimation result of the next main work in the information storage unit 15 as the main result information 53. For example, in a case of the collaborative figure layout work, the main result information 53 is expression of a picture, and the dialogue control unit 13 holds types of figures or coordinates thereof as a text or numerical values. Further, the dialogue control unit 13 outputs the estimation result of the next system utterance that is the next utterance from the own device to the output unit 14.

Here, a matching portion between the estimation result of the next work of the other party and the main result information 53 can be regarded as the common base information 54. That is, in a case where there is an estimation model having a function capable of appropriately imagining the result of the other party, the dialogue device 1 and the user who is the other party of the work can perform a dialogue in consideration of the common base by generating a system utterance on the basis of the estimation model. That is, the dialogue device can implement a system capable of achieving the collaborative figure layout task with the user.

Therefore, the dialogue control unit 13 extracts a part common to the estimation result of the next main work result and the estimation result of the next work result of the other party. Then, the dialogue control unit 13 updates the common base information 54 to the information of the extracted common part. That is, the dialogue control unit 13 estimates the next main result information 53 and the next work result of the other party by using the estimation model on the basis of the utterance information, the information regarding the process of achieving a task by a plurality of workers performing collaborative work through a dialogue, and the main result information 53 and specifies the common base with the user who is the collaborator on the basis of the estimation result.

For example, in a case of the collaborative figure layout work, the dialogue control unit 13 calculates a difference between the vector v_{A, ij} defined between the figures i and j in the figure layout of the worker A and the vector v_{B, ij} similarly defined by the worker B. Then, the dialogue control unit 13 sets a distance thereof as a scale of whether or not the figure is grounded and sets the sum thereof as a scale showing how much the common base has been established as the entire picture to the common base information 54.

Then, the dialogue control unit 13 refers to the common base information 54 to determine how much the common base with the other party of the work has been finished in the work. For example, in a case where the common base information 54 exceeds a predetermined value, the dialogue control unit 13 may determine that the common base capable of solving a task has been obtained and may perform control to end the dialogue. Specifically, the dialogue control unit 13 may generate a system utterance that ends the dialogue. That is, the dialogue control unit 13 generates a system utterance on the basis of the common base with the collaborator. The dialogue control unit 13 may output the common base information 54 to the output unit 14.

As described above, the dialogue control unit 13 acquires information regarding the process of achieving a task by a plurality of workers performing collaborative work through a dialogue and generates a system utterance by using the estimation model on the basis of the utterance information acquired by the utterance information acquisition unit 11, the information regarding the process of achieving the task by the plurality of workers performing the collaborative work through the dialogue, and the main result information 53 indicating an intermediate result of the collaborative work by the own device. More specifically, the dialogue control unit 13 generates a system utterance on the basis of the dialogue intention information 52 indicating a dialogue intention specified by the dialogue intention management unit 12, the utterance information, and the main result information 53.

Description will be continued by referring back to FIG. 1. The output unit 14 receives input of the next system utterance from the dialogue control unit 13. Then, the output unit 14 outputs the acquired system utterance. Here, in a case where there is a plurality of possible utterances, the output unit 14 selects one utterance on the basis of a predetermined priority order such as a lexicographic order and outputs the selected utterance as the system utterance. In a case where there is a plurality of system utterances, the output unit 14 collectively outputs the plurality of system utterances as one system utterance. The output unit 14 may give a character property to the system utterance and perform processing of improving fluency of the system utterance. The character property is given such that, for example, all ends of sentences are converted into “gozaru”. The processing of improving fluency is processing of lexicographically deleting, for example, an unnatural expression or an inappropriate expression.

The output unit 14 may receive input of the common base information 54 from the dialogue control unit 13. In that case, the output unit 14 outputs the acquired common base information 54 to, for example, the other party of the work with whom the dialogue device is having a dialogue. Therefore, the dialogue device 1 and the user who is the other party of the work can hold common recognition indicating approximately what percentage of the common base until completion of the work has been established.

### [Procedure of Learning Processing of Estimation Model]

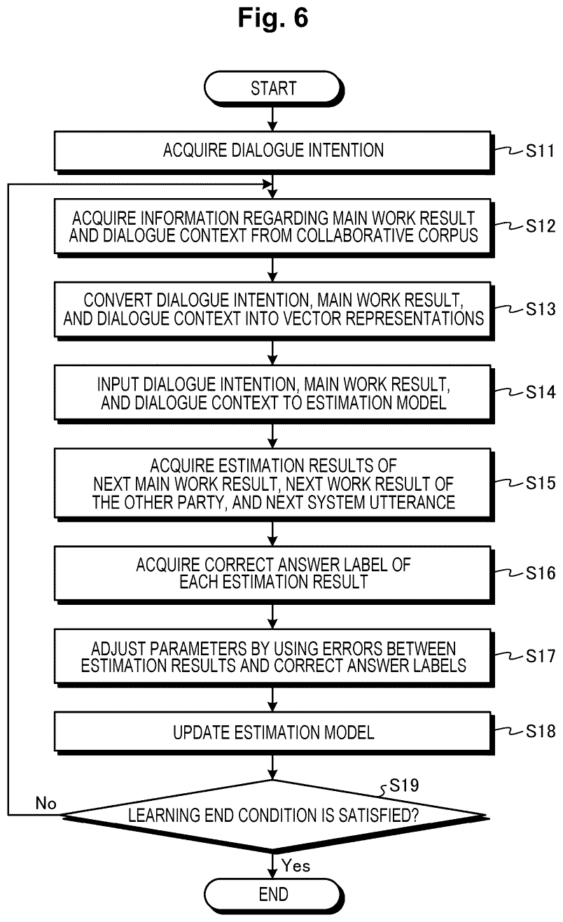

FIG. 6 is a flowchart of a procedure of learning processing of the estimation model by the dialogue device according to the embodiment. Next, a flow of the dialogue control processing by the dialogue device 1 according to the present embodiment will be described with reference to FIG. 6.

The dialogue control unit 13 acquires the dialogue intention information 52 from the information storage unit 15 (step S11).

Next, the dialogue control unit 13 acquires a main work result and a dialogue context from the collaborative corpus 51 (step S12).

The language feature extractor 31 converts the acquired dialogue intention information 52 into a vector representation and converts the vector representation into a format processable by the estimation model 35. The image feature extractor 32 converts the acquired main work result into a vector representation and converts the vector representation into a format processable by the estimation model 35. The feature extractor 33 converts the acquired dialogue context into a vector representation and converts the vector representation into a format processable by the estimation model 35 (step S13).

Next, the dialogue control unit 13 inputs, to the estimation model 35, the dialogue intention information 52, the main work result, and the dialogue context converted into the vector representations (step S14).

The parameter update unit 34 acquires estimation results of a next main work result, a next work result of the other party, and a next system utterance which are outputs from the respective output layers of the estimation model 35 (step S15).

Next, the parameter update unit 34 analyzes the collaborative corpus 51 to acquire correct answer labels corresponding to the estimation results (step S16).

Then, the parameter update unit 34 calculates errors between the estimation results output from the estimation model 35 and the correct answer labels. Thereafter, the parameter update unit 34 adjusts parameters of the estimation model by using the calculated errors (step S17).

Next, the parameter update unit 34 feeds back information regarding the adjusted parameters to the estimation model 35 and updates the estimation model 35 (step S18).

Thereafter, the dialogue control unit 13 determines whether or not the learning end condition is satisfied (step S19). When the learning end condition is not satisfied (step S19: No), the dialogue control unit 13 returns to step S12. Meanwhile, when the learning end condition is satisfied (step S19: Yes), the dialogue control unit 13 ends the learning processing of the estimation model 35.

### [Dialogue Control Processing Procedure]

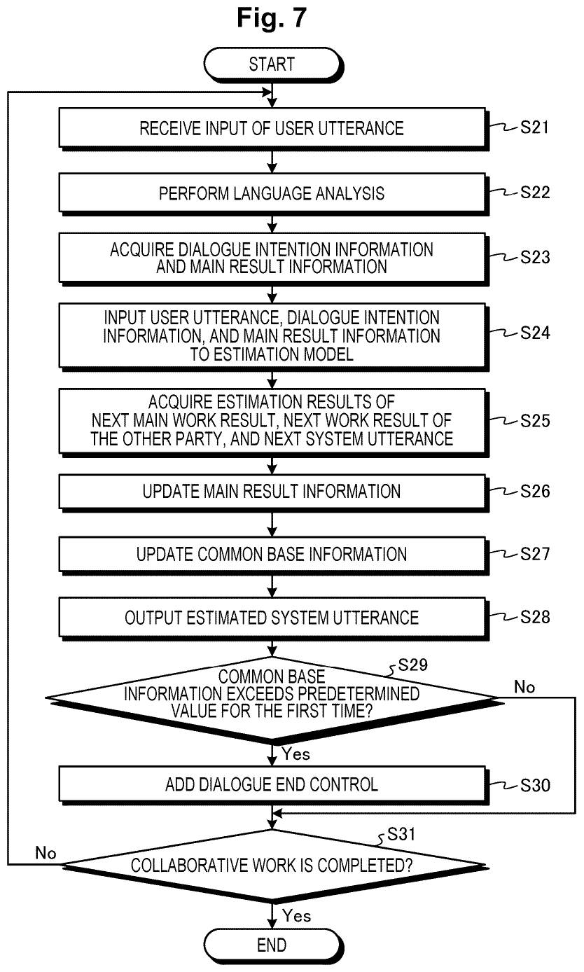

FIG. 7 is a flowchart of the dialogue control processing by the dialogue device according to the embodiment. Next, a flow of the dialogue control processing by the dialogue device 1 according to the present embodiment will be described with reference to FIG. 7.

The utterance information acquisition unit 11 and the dialogue control unit 13 receive input of information regarding a user utterance (step S21).

Next, the utterance information acquisition unit 11 performs language analysis on the acquired user utterance (step S22). Thereafter, the utterance information acquisition unit 11 outputs the analysis result of the user utterance to the dialogue intention management unit 12.

The dialogue control unit 13 acquires the dialogue intention information 52 and the main result information 53 from the information storage unit 15 (step S23).

Next, the dialogue control unit 13 inputs the user utterance, the dialogue intention information 52, and the main result information 53 to an estimation model (step S24).

Next, the dialogue control unit 13 acquires estimation results of a next main work result, a next work result of the other party, and a next system utterance by using an output from the estimation model and the common base information 54 (step S25).

Then, the dialogue control unit 13 updates the main result information 53 by using the estimated next main work result (step S26).

Next, the dialogue control unit 13 updates the common base information 54 (step S27).

Next, the dialogue control unit 13 outputs the estimation result of the next system utterance to the output unit 14. The output unit 14 outputs the estimated system utterance to a terminal or the like of the other party of the dialogue (step S28).

Further, the dialogue control unit 13 determines whether or not the common base information 54 exceeds a predetermined value for the first time (step S29). When the common base information 54 exceeds the predetermined value for the first time (step S29: Yes), the dialogue control unit 13 adds dialogue end control for ending the dialogue (step S30). Thereafter, the dialogue control processing proceeds to step S31.

Meanwhile, when the common base information 54 does not exceed the predetermined value or has already exceeded the predetermined value before (step S29: No), the dialogue control processing proceeds to step S31.

Next, the dialogue control unit 13 determines whether or not the collaborative work has been completed (step S31). In a case where the collaborative work has not been completed (step S31: No), the dialogue control processing returns to step S21. Meanwhile, when the collaborative work has been completed (step S31: Yes), the dialogue control unit 13 ends the dialogue control processing.

### [Effects of Dialogue Control Processing]

As described above, the dialogue device 1 according to the present embodiment grasps a dialogue intention, estimates and updates a next main work result on the basis of a main work result and a user utterance, estimates a next system utterance, and then performs a dialogue. Therefore, the dialogue device can achieve a task of collaborative work using a dialogue with the user. That is, the dialogue device can establish a common base with the user through a dialogue and appropriately establish an estimation model that performs a dialogue on the basis of the common base. Regarding a dialogue involving complicated content, it is preferable to accumulate understanding of the content thereof. For the above point, the dialogue device 1 according to the present embodiment can accumulate the main work results corresponding to understanding by the own device while establishing the common base and can achieve a system capable of having an advanced dialogue of a type such as education, discussion, negotiation, or the like with the user.

Here, in the present embodiment, the collaborative figure layout work of two persons has been described as an example, but other types of processing may be adopted as long as the processing is processing of solving a specific task by collaboratively performing work through a dialogue. For example, the dialogue device 1 according to the present embodiment can also have a similar effect also in processing of determining a layout of furniture.

### [System Configuration and the Like]

Each component of each device illustrated in the drawings is functionally conceptual and does not necessarily need to be physically configured as illustrated. That is, a specific form of distribution and integration of the devices is not limited to the illustrated form, and all or some thereof can be functionally or physically distributed or integrated in an arbitrary unit according to various loads, usage conditions, and the like. The whole or an arbitrary part of each processing function performed in each device can be implemented by a central processing unit (CPU) and a program analyzed and executed by the CPU or may be implemented as hardware by wired logic.

Among the processes described in the embodiment, all or some of the processes described as being automatically performed can be manually performed, or all or some of the processes described as being manually performed can be automatically performed by a known method. In addition, a processing procedure, a control procedure, a specific name, and information including various types of data and parameters described in the above document or illustrated in the drawings can be arbitrarily changed unless otherwise specified.

### [Program]

A program for implementing the functions of the dialogue device 1 described in the above embodiment can be implemented by being installed in a desired information processing device (computer). For example, it is possible to cause the information processing device to function as the dialogue device 1 by causing the information processing device to execute the above program provided as package software or online software. The information processing device herein encompasses desktop and laptop personal computers. The information processing device further encompasses mobile communication terminals such as a smartphone, a mobile phone, and a personal handy-phone system (PHS) and terminals such as a personal digital assistant (PDA). An alert verification device 10 may be implemented in a cloud server.

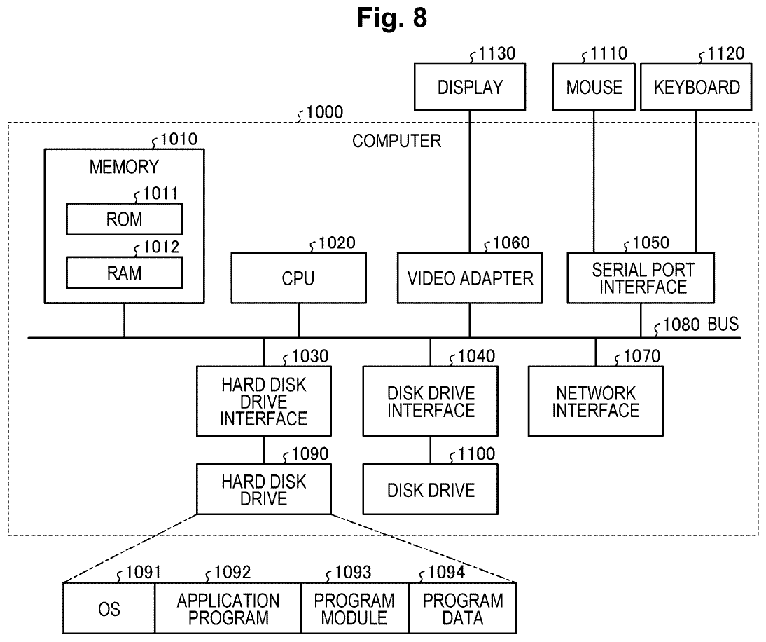

FIG. 8 illustrates an example of a computer that executes a dialogue program for the dialogue control processing. As illustrated in FIG. 8, a computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. For example, the serial port interface 1050 is connected to a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, an alert verification program that has a function equivalent to that of the dialogue device 1 and defines each process of the dialogue device 1 is implemented as the program module 1093 in which a code executable by the computer is written. The program module 1093 is stored in, for example, the hard disk drive 1090. For example, the program module 1093 for performing processing similar to a functional configuration of the dialogue device 1 is stored in the hard disk drive 1090. The hard disk drive 1090 may be replaced with a solid state drive (SSD).

Setting data used in the processing of the above embodiment is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and performs the processing of the above embodiment.

The program module 1093 and the program data 1094 are not limited to being stored in the hard disk drive 1090 and may be stored in, for example, a removable storage medium and be read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from the another computer via the network interface 1070.

### REFERENCE SIGNS LIST

1 Dialogue device
2 Utterance text output device
3 Work terminal device
11 Utterance information acquisition unit
12 Dialogue intention management unit
13 Dialogue control unit
14 Output unit
15 Information storage unit
51 Collaborative corpus
52 Dialogue intention information
53 Main result information
54 Common base information

1. A dialogue device comprising:
utterance information acquisition circuitry that acquires utterance information of a collaborator who performs collaborative work for achieving a task through a dialogue;
dialogue control circuitry that acquires information regarding process of achieving the task by a plurality of workers performing the collaborative work through a dialogue and generates a system utterance by using an estimation model on the basis of the utterance information acquired by the utterance information acquisition circuitry, the information regarding the process, and main result information indicating an intermediate result of the collaborative work by the own device; and
output circuitry that outputs the system utterance generated by the dialogue control circuitry to the collaborator.

2. The dialogue device according to claim 1, further comprising:
dialogue intention management circuitry that specifies a dialogue intention of the dialogue with the collaborator on the basis of the information regarding the process,
wherein the dialogue control circuitry generates the system utterance on the basis of the utterance information, the dialogue intention specified by the dialogue intention management circuitry, and the main result information.

3. The dialogue device according to claim 2, wherein:
the dialogue control circuitry acquires the utterance information and training data of the main result information on the basis of the information regarding the process and updates the estimation model by using the dialogue intention and the training data.

4. The dialogue device according to claim 1, wherein:
the dialogue control circuitry estimates next main result information and a next work result of the collaborator by using the estimation model on the basis of the utterance information, the information regarding the process, and the main result information and specifies a common base with the collaborator on the basis of estimation results.

5. The dialogue device according to claim 4, wherein:
the dialogue control circuitry generates the system utterance on the basis of the common base with the collaborator.

6. A dialogue control method comprising the steps of:
acquiring utterance information of a collaborator who performs collaborative work for achieving a task through a dialogue;
acquiring information regarding process of achieving the task by a plurality of workers performing the collaborative work through a dialogue;
generating a system utterance by using an estimation model on the basis of the utterance information, the information regarding the process, and main result information indicating an intermediate result of the collaborative work by the own device; and
outputting the generated system utterance to the collaborator.

7. A non-transitory computer-readable medium storing a dialogue program for causing a computer to execute the processing of:
acquiring utterance information of a collaborator who performs collaborative work for achieving a task through a dialogue;
acquiring information regarding process of achieving the task by a plurality of workers performing the collaborative work through a dialogue;
generating a system utterance by using an estimation model on the basis of the utterance information, the information regarding the process, and main result information indicating an intermediate result of the collaborative work by the own device; and
outputting the generated system utterance to the collaborator.
